(19) United States
(12) Patent Application Publication
(10) Pub. No.: US 2007/0163546 A1
(43) Pub. Date: Jul. 19, 2007

(54) Vibration-reducing structure for fuel pipe

(75) Inventor: Kenji Yamanari, Chiryu-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, TOYOTA-SHI (JP)

(21) Appl. No.: 11/638,359

(22) Filed: Dec. 14, 2006

(30) Foreign Application Priority Data
Jan. 13, 2006 (JP) 2006-006192

(51) Int. Cl. F02M 69/46

(52) U.S. Cl. 123/456

(57) ABSTRACT

A vibration-reducing structure for a fuel pipe includes a fuel hose, and a pulsation damper. Fuel is supplied to an engine installed in a vehicle through the fuel hose. The pulsation damper is disposed on the fuel hose at a predetermined position. The pulsation damper suppresses pulsations of fuel. The fuel hose is fixed to a vehicle body at the predetermined position.

### INCORPORATION BY REFERENCE

The disclosure of Japanese Patent Application No. 2006-6192 filed on Jan. 13, 2006, including the specification, drawings and abstract is incorporated herein by reference in its entirety.

### BACKGROUND OF THE INVENTION

1. Field of the Invention

The invention generally relates to the vibration-reducing structure for a fuel pipe. More specifically, the invention relates to the vibration-reducing structure for a fuel pipe, in which a pulsation damper is provided on the fuel pipe.

2. Description of the Related Art

Japanese Utility Model Application Publication No. 3-14388 describes the technology relating to the vibration-reducing structure for a fuel pipe. In the technology, a surface-treated pipe is fixed to a support body with high positioning accuracy, without damaging to the treated surface of the pipe. Attachment members are fixed to the metallic pipe at appropriate positions in the longitudinal direction of the pipe. The pipe is fixed to a vehicle-body panel by the attachment members. Each attachment member surrounds the pipe. Each attachment member includes a body formed using resin, and a stay portion fastened to the vehicle-body panel.

Japanese Utility Model Application Publication No. 63-171779 describes a clamp that holds a plurality of pipes including a fuel pipe, and fixes the pipes to a vehicle. Japanese Patent Application Publication No. JP-A-2000-104636 describes a fuel supply device that simplifies the structure of a fuel delivery pipe, reduces the size of the fuel delivery pipe, reduces the number of components, and prevents fuel leaks.

In the fuel pipe through which fuel is supplied to an internal combustion engine such as a gasoline engine, fuel pulsates due to the injection of fuel from a fuel pump or an injector. Thus, in the structure of the fuel pipe described in the above patent publications, the vibrations caused by the pulsations of fuel may be transmitted to the vehicle body from the fuel pipe, and noise (clacks) may occur in a vehicle compartment. This deteriorates the level of noise and vibration in the vehicle.

### SUMMARY OF THE INVENTION

The invention provides the vibration-reducing structure for a fuel pipe, which sufficiently reduces vibrations and noise.

An aspect of the invention relates to a vibration-reducing structure for a fuel pipe, which includes a fuel pipe, and a pulsation damper. Fuel is supplied to an internal combustion engine installed in a vehicle through the fuel pipe. The pulsation damper, disposed on the fuel pipe at a predetermined position, suppresses the pulsations of fuel. The fuel pipe is fixed to a vehicle body at the predetermined position.

In the above-described vibration-reducing structure for a fuel pipe, the pulsation damper is disposed on the path through which the vibrations caused by the pulsations of fuel are transmitted to the vehicle body from the fuel pipe. This reliably suppresses the transmission of the vibrations from the fuel pipe to the vehicle body. As a result, the level of noise and vibration in the vehicle is improved.

The fuel pipe may be fixed to the vehicle body at a plurality of positions that includes the predetermined position. The portion of the vehicle body, to which the fuel pipe is fixed at the predetermined position, has highest stiffness among all the portions of the vehicle body, to which the fuel pipe is fixed at the plurality of positions. In this vibration-reducing structure, the pulsation damper is disposed in the portion that has low vibration-damping performance (i.e., the portion in which vibrations are unlikely to attenuate), and has high stiffness. Thus, the above-described effects can be obtained.

The predetermined position matches the position of the loop of the standing wave when fuel pressure oscillates. The loop of the standing wave is the portion of the standing wave, at which the amplitude is largest. In the vibration-reducing structure for a fuel pipe, the pulsation damper is provided at the position at which the pulsations of fuel are greatly reduced. Thus, the above-described effects can be obtained.

As described above, according to the aspect, it is possible to provide the vibration-reducing structure for a fuel pipe, which sufficiently reduces vibrations and noise.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a plan view showing the engine room of a vehicle to which the vibration-reducing structure for a fuel pipe according to an embodiment of the invention is applied;

FIG. 2 is a cross sectional view of the vehicle, taken along line 11-11 in FIG. 1;

FIG. 3 is a diagram showing the positions of pulsation dampers and a pressure sensor;

FIG. 4 is a graph showing the relation between the amounts of change in fuel pressure and frequencies in experiment;

FIG. 5 is a diagram showing the positions of the pulsation dampers and the pressure sensors in comparative experiment; and

FIG. 6 is a graph showing the relation between the amounts of change in fuel pressure and frequencies in the comparative experiment.

### DETAILED DESCRIPTION OF THE EXAMPLE EMBODIMENTS

An embodiment of the invention will be described with reference to the drawings. In the drawings, the same or corresponding portions are denoted by the same reference numerals.

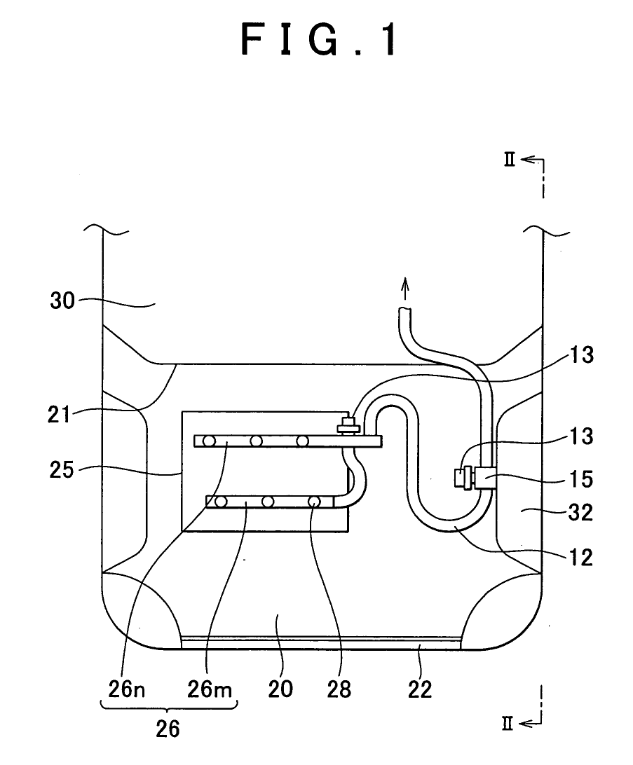

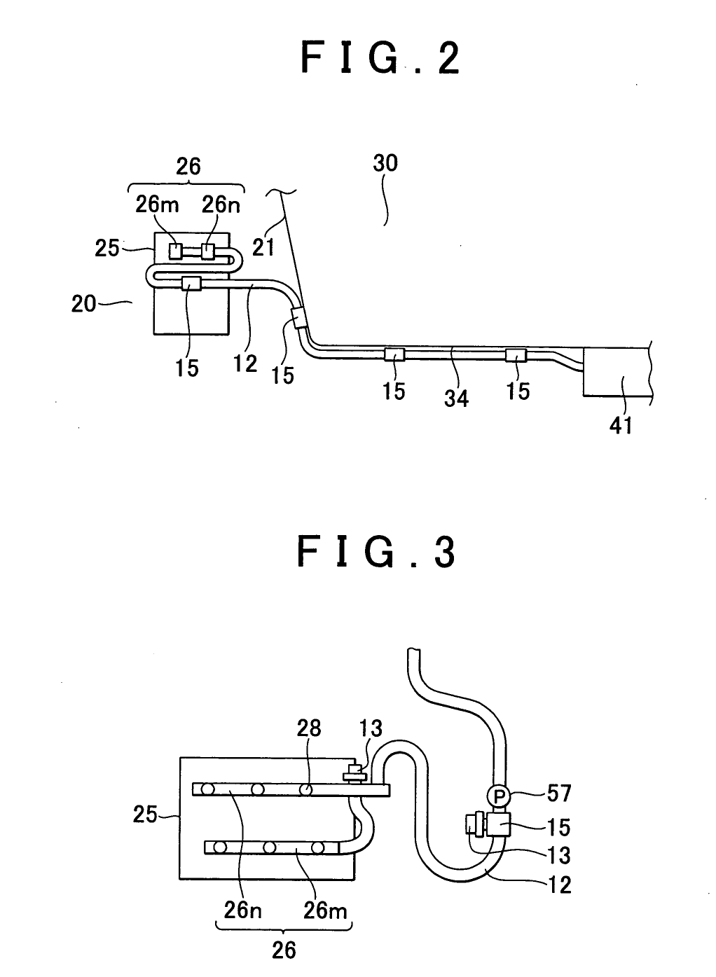

FIG. 1 is a plan view showing the engine room of a vehicle to which a vibration-reducing structure for a fuel pipe according to the embodiment of the invention is applied. FIG. 2 is a cross sectional view of the vehicle, taken along line II-II in FIG. 1.

Hereinafter, the embodiment will be described with reference to FIG. 1 and FIG. 2. An engine 25 is installed in the engine room 20 of a vehicle. The engine room 20 is formed between a front bumper 22 and a cowl board 21. The cowl board 21 is the partition between the engine room 20 and a vehicle compartment 30. Side members 32 are disposed in the engine room 20. The side members 32 constitute the frame of a vehicle body. The side members 32 are disposed at the ends of the vehicle in the lateral direction of the vehicle. The side members 32 extend in the longitudinal direction of the vehicle.

In this embodiment, the engine 25 is a V-6 transverse engine. However, the engine 25 is not limited to the V-6 transverse engine. For example, the engine 25 may be a vertical engine, a V-type engine other than the V-6 engine, an in-line engine, a W-type engine, or a horizontal opposed engine. The engine 25 may be a gasoline engine, or an alcohol engine. The engine 25 may be the internal combustion engine that is installed in a hybrid vehicle. In this case, the hybrid vehicle uses the internal combustion engine and a motor powered by a secondary rechargeable battery, as driving sources.

A fuel tank 41, which stores fuel, is installed in the vehicle. The fuel is supplied to the engine 25 from the fuel tank 41. The position of the fuel tank 41 is not limited. For example, the fuel tank 41 may be positioned in a luggage room in the rear of the vehicle, under a rear seat, or under a front seat. A fuel pump (not shown) is provided in the fuel tank 41. The fuel pump delivers fuel under pressure to the engine 25 from the fuel tank 41.

A delivery pipe 26 is provided on the cylinder head of the engine 25. The delivery pipe 26 may be provided on the intake manifold of the engine 25. The delivery pipe 26 includes a delivery pipe 26n and a delivery pipe 26n. The delivery pipe 26n is disposed in the left bank of the engine 25. The delivery pipe 26n is disposed in the right bank of the engine 25. The delivery pipe 26 may be formed using resin or metal. The fuel supplied from the fuel tank 41 is distributed to the injectors 28 in the cylinders of the engine 25 through the delivery pipe 26.

A fuel hose 12 connects the delivery pipe 26 to the fuel tank 41. The fuel is delivered under pressure to the engine 25 from the fuel tank 41 through the fuel hose 12. The fuel hose 12 extends from the delivery pipe 26 along the side member 32, the cowl board 21, and a floor panel 34 in the stated order. The floor panel 34 constitutes the bottom of the vehicle below the vehicle compartment. The fuel hose 12 is formed using resin. For example, a steel pipe may be provided, instead of the fuel hose 12.

The fuel hose 12 is fixed to the vehicle body by a clamp member 15. The clamp member 15 is formed using metal such as iron. The clamp member 15 may be formed using resin or rubber. The clamp member 15 may be formed by joining vibration-absorbing rubber to a metal member by vulcanization. The fuel hose 12 is fixed to the vehicle body at a plurality of positions between the delivery pipe 26 and the fuel tank 41. The fuel hose 12 is also fixed to the side member 32 in the engine room 20. Further, the fuel hose 12 is fixed to the cowl board 21 and the floor panel 34. The side member 32, which is a portion of the vehicle body, has higher stiffness than the cowl board 21 and the floor panel 34.

A pulsation damper 13 is disposed on the fuel hose 12 that extends from the delivery pipe 26 to the fuel tank 41. The pulsation damper 13 reduces the pulsations of fuel in the fuel hose, which is caused due to the injection of the fuel from the fuel pump or the injector 28. The pulsation damper 13 includes a diaphragm and a coil spring that is an elastic body. The configuration of the pulsation damper 13 is not limited to this configuration. That is, the pulsation damper 13 may have other configurations.

The pulsation damper 13 is disposed at the position at which the fuel hose 12 is fixed to the side member 32. In other words, the pulsation damper 13 is disposed near the portion of the vehicle body, which has highest stiffness among all the portions of the vehicle body to which the fuel hose 12 is fixed. That is, the pulsation damper 13 is disposed near the side member 32. The pulsation damper 13 is adjacent to the clamp member 15.

Further, the position of the pulsation damper 13 matches the position of the loop of the standing wave when fuel pressure oscillates due to the pulsations. For example, a pressure sensor determines the characteristic of the oscillations of fuel pressure in the fuel hose 12. Then, the position of the loop is determined based on the determined characteristic.

Further, another pulsation damper 13 is provided on the delivery pipe 26. That is, in this embodiment, one pulsation damper 13 is provided at the position at which the fuel hose 12 is fixed to the side member 32, and another pulsation damper 13 is provided on the delivery pipe 26. However, the invention is not limited to this configuration. That is, additional pulsation dampers 13 may be disposed at other positions. Alternatively, only one pulsation damper 13 may be disposed at the position at which the fuel hose 12 is fixed to the side member 32. The fuel hose 12 does not necessarily need to be fixed to the vehicle body at plural positions. For example, the fuel hose 12 may be fixed to the vehicle body only at the side member 32.

In this embodiment, the pulsation damper 13 is disposed at the position at which the fuel hose 12 is fixed to the side member 32 in the engine room 20. However, the invention is not limited to this configuration. For example, the pulsation damper 13 may be disposed at the position at which the fuel hose 12 is fixed to the side member 32 in the rear of the vehicle. Alternatively, the pulsation damper 13 may be disposed at the position at which the fuel hose 12 is fixed to a cross member that extends between the side members 32 in the lateral direction of the vehicle.

The vibrations caused by the pulsations of fuel are transmitted to the vehicle body from the fuel hose 12 via the clamp member 15. The transmission of the vibrations is noticeable particularly in the side member that has high stiffness. If the natural vibration frequency of the vehicle body matches the frequency of the pulsations of fuel, the vehicle body and the fuel sympathetically vibrate. As a result, noise (clacks) may occur in the vehicle compartment 30, for example, at the time of idling. This may deteriorate the level of noise and vibration in the vehicle.

In general, a pulsation damper or a chamber is provided at the position near the injector 28 to prevent the deterioration of the level of noise and vibration. Alternatively, the clamp member is formed using soft rubber material.

However, the vibrations transmitted to the vehicle body cannot be sufficiently reduced simply by providing the pulsation damper at the position near the injector 28, because this position near the injector 28 is not the position determined to reduce the vibrations transmitted to the vehicle body. The chamber can reduce only the pulsations having frequencies in an extremely small range. If the clamp member is formed using rubber material, the rubber may be hardened at extremely low temperatures. This may significantly reduce the performance of attenuating the vibrations. Thus, even if the pulsation damper or the chamber is provided at the position near the injector 28, or even if the clamp member is formed using rubber material, the vibrations transmitted to the vehicle body cannot be sufficiently reduced.

In contrast, in this embodiment, the pulsation damper 13 is provided on the path through which the vibrations are transmitted to the side member 32 from the fuel hose 12. The position of the pulsation damper 13 matches the loop of the standing wave when fuel pressure oscillates. Therefore, the pulsation damper 13, disposed near the side member 32, effectively suppresses the pulsations of fuel, and suppresses the transmission of the vibrations from the fuel hose 12 to the vehicle body.

The vibration-reducing structure for a fuel pipe according to the embodiment of the invention includes the fuel hose 12, and the pulsation damper 13. Fuel is supplied to the engine 25 through the fuel hose 12. The engine 25 is regarded as the internal combustion engine installed in the vehicle. The fuel hose 12 is regarded as the fuel pipe. The pulsation damper 13 is disposed on the fuel hose 12 at the predetermined position. The fuel hose 12 is fixed to the side member 32, which is regarded as a portion of the vehicle body, at the predetermined position.

The vibration-reducing structure for a fuel pipe according to the embodiment of the invention suppresses the transmission of the noise, which is caused by the pulsations of fuel, to the vehicle body. This improves the level of noise and vibration.

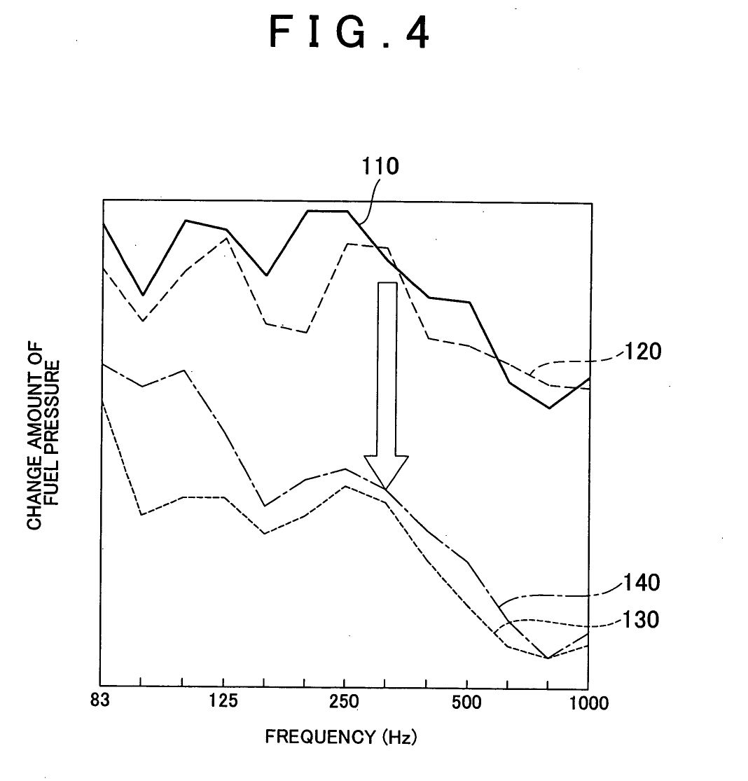

Next, the experiment that was performed using the pipe structure in FIG. 1 to confirm the effect of one embodiment of the invention will be described. FIG. 3 shows the positions of pulsation dampers and the pressure sensor in the experiment. FIG. 4 is a graph showing the relation between the amounts of change in fuel pressure and frequencies.

Hereinafter, the experiment will be described with reference to FIG. 3 and FIG. 4. In this experiment, one pulsation damper 13 was disposed on the delivery pipe 26, and another pulsation damper 13 was disposed on the fuel hose 12. The pulsation sensor 57 was disposed near the pulsation damper 13. The amount of change in the fuel pressure at each frequency was determined by performing the frequency analysis of the changes in the fuel pressure measured by the pressure sensor 57. The amounts of change in the fuel pressure were determined also in the case where the pulsation damper 13 was not provided. The natural vibration frequency of the vehicle body was 300 Hz.

In FIG. 4, a curve 110 shows the case where the pulsation damper 13 was not provided. A curve 120 shows the case where the pulsation damper 13 was disposed on the delivery pipe 26n. A curve 130 shows the case where the pulsation dampers 13 were disposed near the side member 32, and on the delivery pipe 26n. A curve 140 shows the case where the pulsation damper 13 was disposed near the side member 32.

As shown in FIG. 4, in the case where the pulsation damper 13 was provided near the side member 32, the amount of change in the fuel pressure was reduced when the frequency was approximately 300 Hz, as compared to the case where the pulsation damper was not provided.

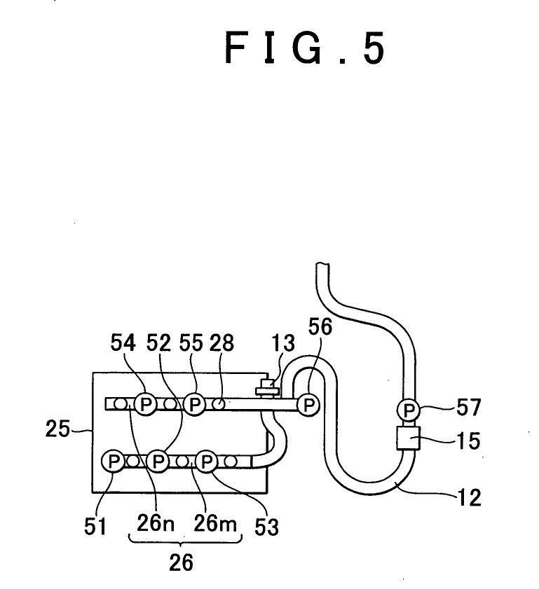

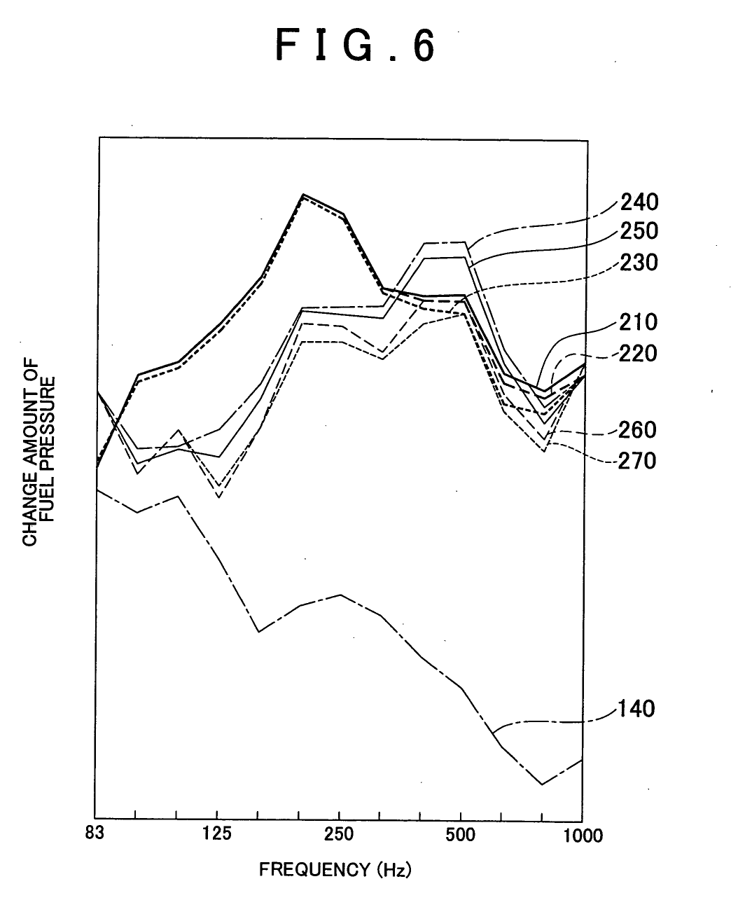

Further, the comparative experiment that was performed using the pipe structure in FIG. 1 to confirm the effect of one embodiment of the experiment will be described. FIG. 5 shows the positions of the pulsation dampers and the pressure sensors in the comparative experiment. FIG. 6 is a graph showing the relation between the amounts of change in the fuel pressure and the frequencies.

Hereinafter, the comparative experiment will be described with reference to FIG. 5 and FIG. 6. In this comparative experiment, the pulsation damper 13 was provided only on the delivery pipe 26n. The pressure sensor 57 was provided near the pulsation damper 13. A plurality of pressure sensors 51 to 57 was provided on the delivery pipe 26 in FIG. 5. In FIG. 6, curves 210 to 270 show the amounts of change in the fuel pressure at the positions where the respective pressure sensors 51 to 57 were disposed. In FIG. 6, the curve 140 is also shown for comparison. The curve 140 shows the case where the pulsation damper 13 was provided near the side member 32 in FIG. 4.

As shown in FIG. 6, in this comparative experiment, the amount of change in the fuel pressure was large when the frequency was approximately 300 Hz, as compared to the case where the pulsation damper 13 was disposed near the side member.

The embodiment of the invention that has been disclosed in the specification is to be considered in all respects as illustrative and not restrictive. The technical scope of the invention is defined by claims, and all changes which come within the meaning and range of equivalency of the claims are therefore intended to be embraced therein.

What is claimed is:

1. A vibration-reducing structure for a fuel pipe, comprising:
a fuel pipe through which fuel is supplied to an internal combustion engine installed in a vehicle;
a pulsation damper which is disposed on the fuel pipe at a predetermined position, and which suppresses pulsations of fuel, wherein the fuel pipe is fixed to a vehicle body at the predetermined position.

2. The vibration-reducing structure according to claim 1, wherein
the fuel pipe is fixed to the vehicle body at a plurality of positions that includes the predetermined position; and
a portion of the vehicle body, to which the fuel pipe is fixed at the predetermined position, has highest stiffness among all portions of the vehicle body, to which the fuel pipe is fixed at the plurality of positions.

3. The vibration-reducing structure according to claim 2, wherein
the predetermined position matches a position of a loop of a standing wave when fuel pressure oscillates.

4. The vibration-reducing structure according to claim 1, wherein
the predetermined position matches a position of a loop of a standing wave when fuel pressure oscillates.
